(19) United States
(12) Patent Application Publication
(10) Pub. No.: US 2026/0088554 A1
(43) Pub. Date: Mar. 26, 2026

(54) HIGH VOLTAGE POWER CONNECTOR SYSTEM

(71) Applicant: FCI USA LLC, Etters, PA (US)

(72) Inventors: Thomas A. Brungard, Lewisberry, PA (US); Christopher S. Gieski, Dillsburg, PA (US); Steven E. Pressel, Hazleton, PA (US)

(73) Assignee: FCI USA LLC, Etters, PA (US)

(21) Appl. No.: 19/408,839

(22) Filed: Dec. 4, 2025

Related U.S. Application Data
(60) Provisional application No. 63/857,752, filed on Aug. 5, 2025.

(51) Int. Cl. H01R 13/44; H01R 13/02; H01R 13/504; H01R 13/627; H01R 13/629

(52) U.S. Cl. CPC H01R 13/44; H01R 13/025; H01R 13/504; H01R 13/6273; H01R 13/62938

(57) ABSTRACT

A high voltage power connector system including a cable assembly with a receptacle connector and a mating plug connector, both of which may be touch proof. The receptacle connector may include contacts within openings in the connector housing. The openings may receive at least an 8 mm contact from the plug connector. The receptacle may have an insulative pin within the opening to make the receptacle connector touch proof. The contacts of the plug connector may include an opening to receive the insulative pin. Reduced mating force may be achieved with polarizing features on structures associated with different contacts in the connector system oriented differently such that any force generated by engagement of one set of polarizing features is offset by others of the polarizing features. A cable assembly may be flexible as a result of a junction block connecting a large diameter cable bunder to multiple smaller diameter cables.

### CROSS-REFERENCE TO RELATED APPLICATIONS

This application claims priority to and the benefit under 35 U.S.C. 119 of U.S. provisional patent application 63/857,752 filed Aug. 5, 2025, titled “HIGH VOLTAGE POWER CONNECTOR SYSTEM,” the contents of which is hereby incorporated herein by reference in its entirety.

### FIELD

The present disclosure relates generally to the technical field of electrical connectors and particularly to electrical connectors for power cables.

### BACKGROUND

Electrical connectors are used to connect two or more electronic devices to provide a reliable electrical connection. In a data center, electrical connectors connect electronic components and supply electrical power.

### SUMMARY

In some aspects, the techniques described herein relate to a receptacle connector, including: a housing having tubular protrusions, the tubular protrusions having receptacle contacts at inner sides of the tubular protrusions, the tubular protrusions extending along a plugging and unplugging direction of the receptacle connector; and insulating pins extending within the tubular protrusions along the plugging and unplugging direction of the receptacle connector.

In some aspects, the techniques described herein relate to a receptacle connector, wherein the insulating pins protrude from an interior of the tubular protrusions to an exterior of the tubular protrusions.

In some aspects, the techniques described herein relate to a receptacle connector, wherein the insulating pins are attached to the housing within the tubular protrusions.

In some aspects, the techniques described herein relate to a receptacle connector, wherein the insulating pins are attached to the housing at proximal ends of the tubular protrusions.

In some aspects, the techniques described herein relate to a receptacle connector, wherein the receptacle contacts includes inner protrusions extending within the tubular protrusions along the plugging and unplugging direction of the receptacle connector, and the insulating pins are attached to distal ends of the inner protrusions.

In some aspects, the techniques described herein relate to a receptacle connector, wherein the inner protrusions are conductive.

In some aspects, the techniques described herein relate to a receptacle connector, wherein the insulating pins are positioned at central portions of the tubular protrusions.

In some aspects, the techniques described herein relate to a receptacle connector, wherein the insulating pins are configured to prevent a person from contacting the receptacle contacts.

In some aspects, the techniques described herein relate to a receptacle connector, further including at least one securing structure configured to attach the receptacle connector to a plug connector.

In some aspects, the techniques described herein relate to a receptacle connector, wherein the at least one securing structure includes a rotating latch.

In some aspects, the techniques described herein relate to a receptacle connector, wherein the tubular protrusions are arranged in at least one row.

In some aspects, the techniques described herein relate to a receptacle connector, wherein the tubular protrusions are arranged in a single row and a quantity of tubular protrusions arranged in the single row is five.

In some aspects, the techniques described herein relate to a receptacle connector, wherein the tubular protrusions are arranged in a first row and a second row, a quantity of tubular protrusions arranged in the first row is four, and a quantity of the tubular protrusions arranged in the second row is three.

In some aspects, the techniques described herein relate to a cable assembly including the receptacle connector, the cable assembly further including: a cable overmold at a proximal end of the housing; cables electrically connected to the receptacle contacts, the cables extending from a proximal end of the cable overmold, wherein the cables are arranged in a single row; and a junction block attached to proximal ends of the cables, the junction block being configured to connect the cables to a cable bundle.

In some aspects, the techniques described herein relate to a receptacle connector, wherein the receptacle connector is a right-angle connector.

In some aspects, the techniques described herein relate to a plug connector, including: a housing including recesses, the recesses having plug contacts extending along a plugging and unplugging direction of the plug connector, wherein the plug contacts have holes extending along the plugging and unplugging direction of the plug connector, wherein the holes are configured to accommodate insulating pins of a receptacle connector.

In some aspects, the techniques described herein relate to a plug connector, further including insulating caps attached to distal ends of the plug contacts.

In some aspects, the techniques described herein relate to a plug connector, wherein the insulating caps have holes to accommodate the insulating pins.

In some aspects, the techniques described herein relate to a plug connector, wherein the plug contacts have an external cross-section that is circular.

In some aspects, the techniques described herein relate to a plug connector, wherein an outer diameter of the plug contacts is approximately eight millimeters.

In some aspects, the techniques described herein relate to a receptacle connector, including: a housing having tubular protrusions, the tubular protrusions having receptacle contacts at inner sides of the tubular protrusions, the tubular protrusions extending along a plugging and unplugging direction of the receptacle connector; and polarizing projections at an exterior of at least some of the tubular protrusions, the polarizing projections extending along a plugging and unplugging direction of the receptacle connector, wherein a first polarizing projection is positioned at a top of a first tubular protrusion and a second polarizing projection is positioned at a bottom of a second tubular protrusion.

In some aspects, the techniques described herein relate to a receptacle connector, wherein: the polarizing projections on the at least some of the tubular protrusions extend in a plurality of directions distributed such that, upon mating with a corresponding plug connector, bias of the receptacle connector in a direction perpendicular to the plugging and unplugging direction by any of the polarizing projections is offset at least in part by one or more others of the polarizing projections.

In some aspects, the techniques described herein relate to a receptacle connector, wherein consecutive tubular protrusions along a row direction have polarizing projections at positions that alternate between a top and bottom of the tubular protrusions.

In some aspects, the techniques described herein relate to a cable assembly including the receptacle connector, the cable assembly further including: a cable overmold at a proximal end of the housing; cables electrically connected to the receptacle contacts, the cables extending from a proximal end of the cable overmold, wherein the cables are arranged in a single row; and a junction block attached to proximal ends of the cables, the junction block being configured to connect the cables to a cable bundle.

In some aspects, the techniques described herein relate to a receptacle connector, wherein the tubular protrusions are arranged in a first row and a second row, a quantity of tubular protrusions arranged in the first row is four, and a quantity of tubular protrusions arranged in the second row is three.

In some aspects, the techniques described herein relate to a receptacle connector, wherein the receptacle connector is a right-angle connector.

In some aspects, the techniques described herein relate to a receptacle connector, further including a securing structure configured to attach the receptacle connector to a plug connector.

In some aspects, the techniques described herein relate to a receptacle connector, wherein the securing structure includes a rotating latch.

In some aspects, the techniques described herein relate to a plug connector, including: a housing including: recesses having plug contacts extending along a plugging and unplugging direction of the plug connector; and polarizing slots at inner surfaces of the recesses, the polarizing slots extending along the plugging and unplugging direction of the plug connector, the polarizing slots including at least a first polarizing slot positioned at a bottom inner surface of a first recess and a second polarizing slot positioned at a top inner surface of a second recess.

In some aspects, the techniques described herein relate to a plug connector, wherein: the polarizing slots on the at least some of the inner surfaces of the recesses extend in a plurality of directions distributed such that, upon mating with a corresponding receptacle connector, bias of the plug connector in a direction perpendicular to the plugging and unplugging direction by any of the polarizing slots is offset at least in part by one or more others of the polarizing slots.

In some aspects, the techniques described herein relate to a plug connector, wherein consecutive recesses have polarizing slots at positions that alternate between a top and bottom of the recesses.

In some aspects, the techniques described herein relate to a plug connector, wherein the housing is configured to be mounted to a substrate by a fastener.

In some aspects, the techniques described herein relate to a cable assembly, including: a connector, including: a housing having a plurality of openings extending along a plugging and unplugging direction of the connector; a plurality of contacts within respective openings of the plurality of openings; and insulating structures within the respective openings so as to make the connector touch proof; a cable bundle including a plurality of cables electrically coupled to the plurality of contacts, respectively; and a junction block including a plurality of conductive members attached to the plurality of cables.

In some aspects, the techniques described herein relate to a cable assembly, further including cables electrically connected to the plurality of contacts, the cables extending from a proximal end of the junction block, wherein the cables are arranged in a single row.

In some aspects, the techniques described herein relate to a cable assembly, wherein the connector is a receptacle connector and a quantity of second cables in the single row is five.

In some aspects, the techniques described herein relate to a cable assembly, wherein: the junction block is configured such that at least some of the plurality of cables are each coupled to multiple contacts of the plurality of contacts.

### BRIEF DESCRIPTION OF THE DRAWINGS

In the drawings, each identical or nearly identical component that is illustrated in various figures may be represented by a like numeral. For purposes of clarity, not every component may be labeled in every drawing. In the drawings:

FIGS. 1A and 1B are front perspective views of exemplary high voltage board connectors, with different contact configurations;

FIGS. 2A and 2B are perspective front right and front left, respectively, views of portions of a cable assembly with an exemplary high voltage cable connector configured to mate with the board connector of FIG. 1A;

FIG. 2C is a front, left side perspective view of a portion of a cable assembly with an exemplary high voltage cable connector configured to mate with the board connector of FIG. 1B;

FIG. 3A is an exploded view of the high voltage board connector of FIG. 1A;

FIG. 3B is an exploded view of the high voltage cable connector of FIGS. 2A and 2B;

FIG. 3C is an exploded view of the high voltage cable connector of FIG. 2C;

FIG. 3D shows a perspective view of a plug contact.

FIG. 3E shows a front view of an insulating cap.

FIG. 3F shows a rear perspective view of the insulating cap.

FIGS. 4A and 4B are sectional views of an exemplary terminal usable in a high voltage board connector as described herein and an exemplary terminal usable in a high voltage cable connector as described herein aligned for mating and mated, respectively;

FIG. 5 is a section view of another example of a touch proof feature in a high voltage cable connector as described herein.

### DETAILED DESCRIPTION

Described herein are new designs for electrical connectors that support high voltage separable interfaces, such as may be used to connect AC power sources to power shelves within a data center. With these designs, a cable connector and a complementary board connector may be touch proof when unmated. Herein, touch proof may indicate compliance with IEC 62368. Alternatively or additionally, these designs may support high current contacts while limiting the connector mating force.

As industry demands for computational power for artificial intelligence and other applications continue to increase, there is a demand for higher power levels to be provided to computing resources in data centers. Higher power levels can be provided by increasing the current and/or the voltage supplied. The inventors have recognized and appreciated that, there is a need for connectors and cables to provide significant electric current in data centers, such as 100 A-125 A or greater, such as 125 A-150 A or greater. For example, cables and connectors may supply alternating current from an alternating current supply to a data center rack. In some data centers, AC/DC conversion may be performed at the data center rack (or another location) to convert alternating current into direct current. Cables and connectors are then used to provide the direct current to the computing modules (e.g., through a busbar or another conductor). The cables and connectors described herein may be used in particular for providing alternating current, although the present application is not limited in this respect, as in other applications the cables and connectors as described herein may be used to provide direct current.

The inventors have also recognized and appreciated challenges that arise due to the increased currents and/or voltages used in data centers and similar installations. As power needs increase, the voltage levels provided through a cable assembly to a rack has increased. Voltage levels in the cables, and connectors terminated to them, now may be in the range of hundreds of volts, which exceeds safety limits for human contact. Additionally, because more than one cable may provide power from the same source or to the same location, such as the same power shelf in a data center rack, a connector designed to mate with such a cable assembly may be energized even when the cable assembly intended to carry power to that connector is disconnected. As such mating connectors are conventionally not expected to be energized when the cable assembly is disconnected, the use of a conventional connector for mating to a cable assembly may pose a safety risk.

Further, as higher levels of electric current are needed, the contacts may be larger in cross-section to accommodate the increased current while keeping the series resistance and corresponding heat dissipation low. Contacts with an increased size (e.g., diameter), even if positioned in an opening of a connector housing, may be easier for a person to touch inadvertently because the openings of the housing may be larger. For example, if a receptacle connector is increased in size there is an increased opening size and greater opportunity for a person to touch an electrical contact within the receptacle connector. Connector designs as described herein may enhance safety by reducing the likelihood of a person inadvertently touching the contacts in both connectors of a set of mating connectors, even when the connectors are unmated.

The inventors have further recognized and appreciated designs to reduce mating force, which can be large for large contacts that carry high current. Such designs may limit the bias on one of the mating connectors with respect to the other, which could otherwise increase the mating force. Such a bias can be introduced by polarizing features. Connector designs as describe herein may include polarizing features, such as projections and recesses, distributed such that a bias introduced by any of the polarizing features is offset, in whole or in part, by a bias in another direction introduced by one or more of the other polarizing features.

The inventors have further recognized and appreciated designs to ease assembly of an electronic system using a high current cable assembly. A cable bundle delivering a large amount of current, such as in excess of 100 A may have thick wires, such as 1 AWG, that are relatively inflexible. The wires of the cable bundle may be connected to conductive elements within a junction block where connections may be made between each of the wires of the cable bundle and one or more contacts of a connector. An overmold on the junction block and a portion of the cable bundle may facilitate such a construction. In some examples, the connections between the junction block and the contacts of the connector may be made of smaller diameter wire, such as 2 AWG wire. The smaller diameter wires may be more flexible, facilitating routing the cable assembly within an electronic system into a position where the connector of the cable bundle can mate with a complimentary connector.

The design techniques as described herein may be used separately or together in any combination to provide any one or more of these benefits.

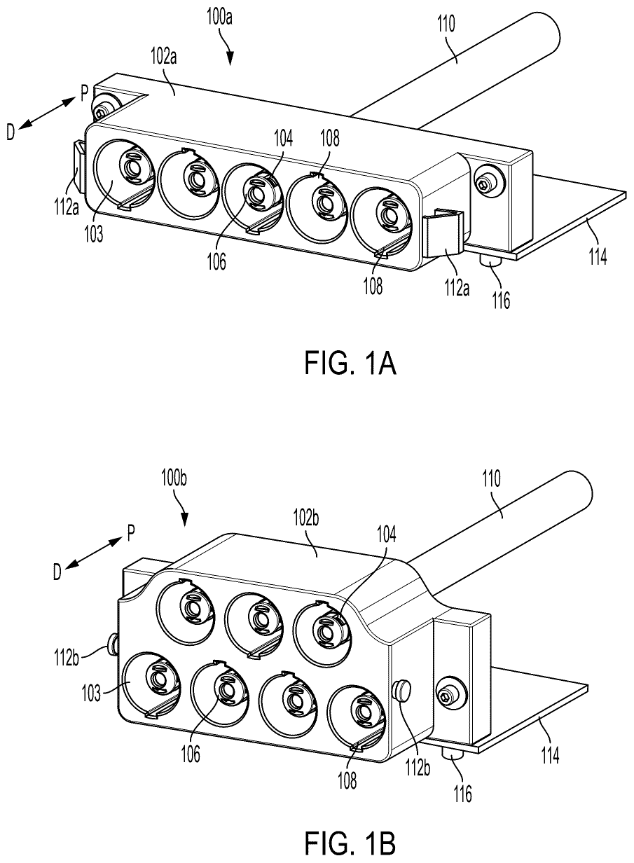

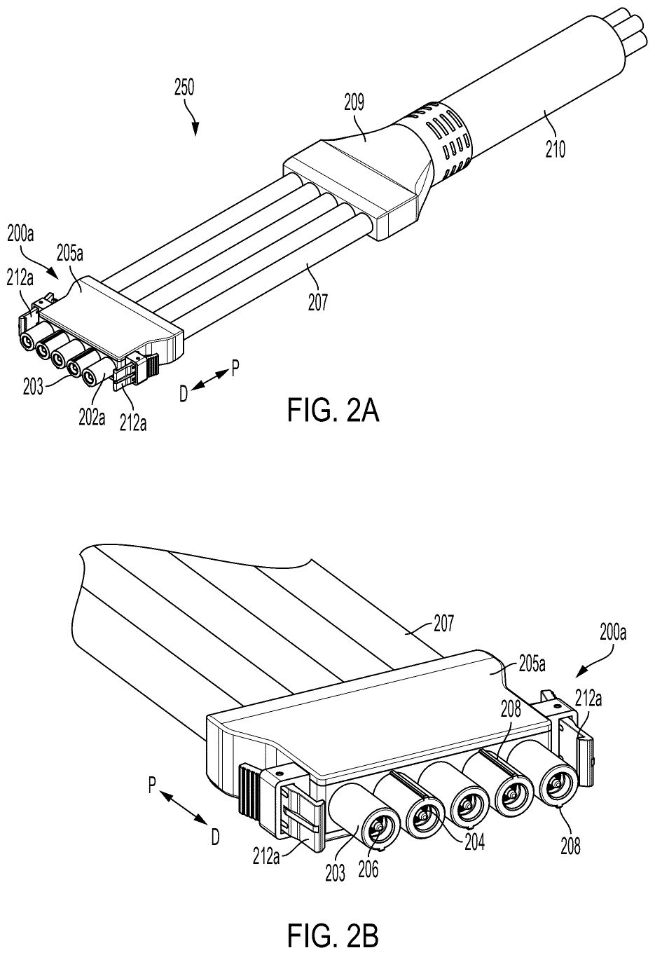

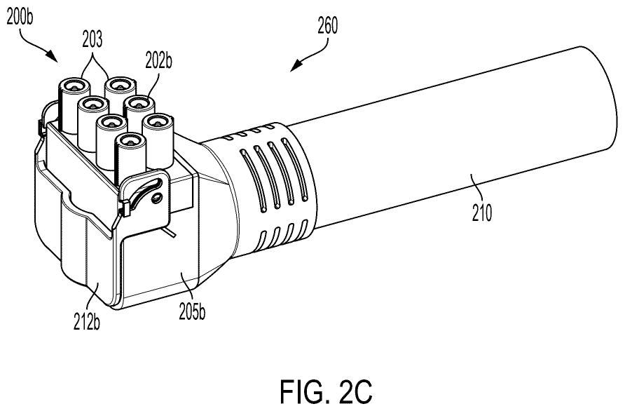

FIGS. 1A-2C show examples of electrical connectors, according to some embodiments. FIGS. 1A and 1B show examples of electrical connectors that are plug connectors as well as board connectors, such as might be attached to a printed circuit board (PCB) in a power shelf of a rack, according to some embodiments. FIGS. 2A-2C show examples of cable assemblies having receptacle connectors at one end, according to some embodiments. The other end of the cable assemblies is not shown, but may be connected to an AC power source. As discussed further below, the plug connector of FIG. 1A may be mated with the receptacle connector of FIG. 2A by plugging the plug connector into the receptacle connector of FIG. 2A. Similarly, the plug connector of FIG. 1B may be mated to the receptacle connector of FIG. 2C by plugging the plug connector into the receptacle connector of FIG. 2C.

FIG. 1A shows an example of a plug connector 100a, according to some embodiments. The plugging and unplugging direction is illustrated with a two-headed arrow, with the proximal direction P and distal direction D labeled, with the mating or plugging direction being labeled D and the unmating or unplugging direction being labeled P. Plug connector 100a has a housing 102a with a plurality of recesses 103 arranged in a row. Within each recess is disposed a plug contact 104 for making physical and electrical contact with the contact of a receptacle connector. Plug connector 100a is shown as having five recesses 103 and corresponding plug contacts 104 in this example. However, this is an example, and a plug connector may have any number of recesses and contacts, such as fewer than five (e.g., two, three or four), or more than five (e.g., six, seven, eight or more). The recesses 103 may have a generally cylindrical shape. The plug contacts 104 may be protrusions having an annular or cylindrical cross-section. The plug contacts 104 may have any suitable diameter, and some may have a diameter of 7-9 mm, such as 8 mm, as an example, which may allow carrying significant current (e.g., 100 A-150 A or more) with low series resistance. Within each recess 103, the plug connector 100a has a space with an annular cross-section between the plug contact 104 and the wall of the recess 103. The space accommodates a portion of a complementary receptacle connector when the plug connector 100a is mated with the receptacle connector.

In some embodiments, an insulating cap 106 is positioned at the tip of each plug contact 104 to prevent or reduce the likelihood of unwanted contact (e.g., by a human) with the plug contact 104, thereby improving safety. An insulating cap 106 may block an object inserted into a recess 103 from touching the plug contact 104. The insulating cap 106 may be attached to the distal end of each plug contact 104. The insulating caps 106 may have a hole in a central portion thereof to provide a space for an insulating pin of a complementary receptacle connector, as discussed further below. The hole may have a similar diameter to such an insulating pin, such as a diameter of 1 mm to 4 mm, for example, or approximately 10% to 50% of the diameter of a plug contact 104. In other embodiments, the insulating caps 106 may not have a hole, or the insulating caps 106 may be omitted.

The recesses 103 may include one or more polarizing features, such as slots or projections. In this example, the recesses 103 include slots 108 designed to accommodate corresponding polarizing projections on complementary portions of the housing of a receptacle connector. As illustrated, the polarizing slots 108 may be recessed into a side of the recess, and may extend along a plugging and unplugging direction. When the plug connector 100a is mated with a receptacle connector, corresponding polarizing projections may extend into the polarizing slots 108. In some embodiments, and as shown in FIG. 1A, the polarizing slots 108 may have alternating locations, with the position of the polarizing slots 108 alternating between the top of the recess 103 and the bottom of the recess 103 for consecutive recesses along the row direction. Alternating the positions of the polarizing features (e.g., polarizing slots) may help to balance forces during plugging or unplugging of the connectors and avoid high localized mating forces. By alternating the positions of the polarizing features, a bias introduced by any of the polarizing features is offset, in whole or in part.

The plug connector 100a includes at least one securing structure 112a for securing the plug connector 100a to a receptacle connector. In this example, the plug connector 100a includes two securing structures 112a located on two ends of the housing 102a outside of the recesses 103 in the row direction. However, a different number of securing structures may be provided, and they may be located in any suitable location. In this example, the securing structures 112a are tabs for engaging with corresponding latches on a receptacle connector. However, this is an example, and other securing structures 112a may be used, at least one example of which is discussed below.

The plug contacts 104 may be connected to a cable 110 that protrudes from the proximal side of the housing 102a. The cable may have an insulating sheath covering any suitable diameter or gauge of conductor. In some embodiments, the cable 110 may be a 2 AWG or 1 AWG cable.

In some embodiments the connector 100a may be mounted to a substrate 114, such as a printed circuit board, for example. The connector 100a may be mounted to the substrate 114 by one or more fasteners 116, which may be screws that attach to threaded holes at the bottom of the connector housing 102a through the underside of the substrate 114. However, this is an example, and if connector 100a is mounted to a substrate it may be mounted in any suitable manner.

The plug connector 100b may be made of any suitable materials. The housing 102b may be formed of electrically insulating material that is relatively rigid, such as molded plastic. The plug contacts 104 may be formed of any suitable conductive material, such as copper, for example. As mentioned above, the insulating caps 106 may be formed of a suitable insulating material. The term “insulating” in the context of the present application refers to an electrically insulating material.

FIG. 1B shows an example of a plug connector 100b, according to some embodiments. Plug connector 100b differs from plug connector 100a in a number of ways. For example, plug connector 100b has two rows of recesses 103 with corresponding plug contacts 104. In this example, the bottom row has four recesses 103 and the top row has three recesses. Plug connector 100b may provide a different form factor from connector 100a, as connector 100b may be less wide than plug connector 100a and taller than plug connector 100a. Other aspects of plug connector 100b may be the same as or similar to those of plug connector 100a with the same reference numbers. Another difference with plug connector 100b is that the one or more securing structures 112b are illustrated to be circular protrusions that are designed to be accommodated in a securing slot of a receptacle connector as it is rotated over the securing structure 112b, as shown further below.

FIG. 2A shows an example of a cable assembly 250 having a receptacle connector 200a configured to mate with plug connector 100a, according to some embodiments.

The receptacle connector 200a includes a cable overmold 205a and a housing 202a. The housing 202a includes a number of tubular protrusions 203 arranged in a row. The tubular protrusions 203 are insulating portions of the housing 202a that house respective receptacle contacts 204 (FIG. 2B) for making contact with the plug contacts 104 of a plug connector 100a when the plug connector 100a is connected to the receptacle connector 200a. Receptacle connector 200a is shown as having five tubular protrusions 203 and corresponding receptacle contacts 204. However, this is an example, and a receptacle connector may have any number of tubular protrusions and contacts, such as fewer than five (e.g., two, three or four), or more than five (e.g., six, seven, eight or more), and may correspond to the number of plug contacts on a complementary plug connector.

FIG. 2A also shows the receptacle connector 200a has at least one securing structure 212a for securing the receptacle connector 200a to the plug connector 100a. In this example, the receptacle connector 200a includes two securing structures 212a located on two ends of the housing 202a, outside of the tubular protrusions 203 in the row direction. However, a different number of securing structures may be provided, and they may be located in any suitable location. The number and location of the securing structures 212a may correspond to the number and location of the securing structures 112a. In this example, the securing structures 212a are latches for engaging with corresponding tabs of the plug connector 100a. When attached, the front of the latch engages with the corresponding tab on the plug connector 100a. A latch may be disengaged by pressing on the proximal portion of the latch, thereby rotating the distal portion of the latch clear of the tab to permit disengagement. As mentioned above, latches are described and illustrated as an example of a securing structure, and other types of securing structures may be used.

FIG. 2B shows a different view of the receptacle connector 200a to illustrate aspects of the mating interface. As shown, each of the tubular protrusions 203 has an inner cylindrical space housing a receptacle contact 204. Receptacle contact 204 may be located at the inner surface of a tubular protrusion 203. The receptacle contact 204 may have a generally cylindrical shape. Receptacle contact 204 may be configured to press inward onto the plug contact 104 when the plug contact 104 is inserted into a tubular protrusion 203, which may provide for a robust electrical connection.

In some embodiments, insulating pins 206 extend in a plugging and unplugging direction from an interior of a tubular protrusions 203. As shown in FIG. 2B, the insulating pins 206 may be positioned at the center of the respective tubular protrusions 203. The insulating pins 206 are configured to prevent or reduce the likelihood of unwanted contact (e.g., by a human) with the receptacle contact 204, thereby improving safety. The tips of the insulating pins 206 may be recessed within a tubular protrusion 203, flush with the front of a tubular protrusion 203, or may protrude from the front of a tubular protrusion 203.

The tubular protrusions 203 include one or more polarizing features such as polarizing projections or slots. In this example, the tubular protrusions 203 include polarizing projections 208 designed to be inserted into corresponding polarizing slots 108 of the recesses 103 of plug connector 100a. The polarizing projections 208 and polarizing slots 108 ensure that the connectors are not able to be mated in an incorrect orientation. As illustrated, the polarizing projections 208 may protrude from an exterior surface of a polarizing projection 208, and may extend in a plugging and unplugging direction. When the receptacle connector 200a is mated with a plug connector 100a, corresponding polarizing projections 208 may extend into the slots 108. In some embodiments, and as shown in FIG. 2B, the polarizing projections 208 may have alternating locations, with the position of the projections 208 alternating between the top of the tubular protrusions 203 and the bottom of the tubular protrusions 203 for consecutive tubular protrusions along the row direction. As mentioned above, alternating the location of the polarizing projections 208 and polarizing slots 108 helps to balance forces normal to the mating interface, and reduces the mating force.

The receptacle connector 200a may be made of any suitable materials. The housing 202a may be formed of electrically insulating material that is relatively rigid, such as molded plastic. The receptacle contacts 204 may be formed of any suitable conductive material, such as copper or a copper alloy, for example. As mentioned above, the insulating pins 206 may be formed of a suitable insulating material.

As shown in FIG. 2A, the cable assembly 250 includes a junction block 209 connected to receptacle connector 200a by cables 207. Junction block 209 provides a region in which the conductors of cables 207 are electrically connected to the conductors of cable bundle 210. Junction block 209 may have a housing formed as an overmold (e.g., formed of molded plastic) or another suitable material. The cables 207 are arrayed in a flat configuration with a single row of cables 207, similar to a ribbon cable. The cables 207 may be attached to one another or not attached to one another. It is appreciated that the cable bundle 210 may be relatively large in diameter and rigid, and difficult to bend into a suitable position for installation. The flat configuration of cables 207 allows for additional flexibility, as it allows for easier bending the cables 207 in a direction perpendicular to the flat side of the ribbon configuration (e.g., up or down in FIG. 2A) as compared to cable bundle 210, which can facilitate installation of the receptacle connector 200a in a desired location.

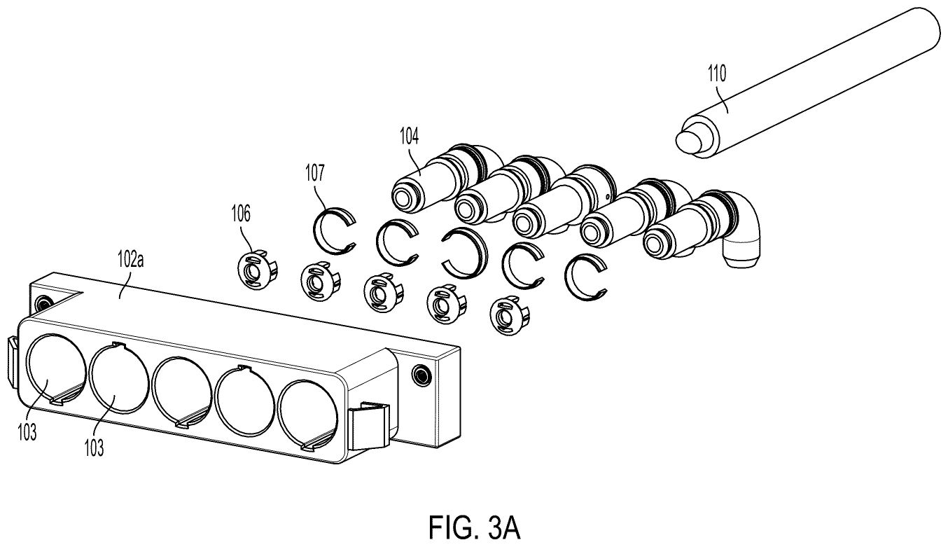

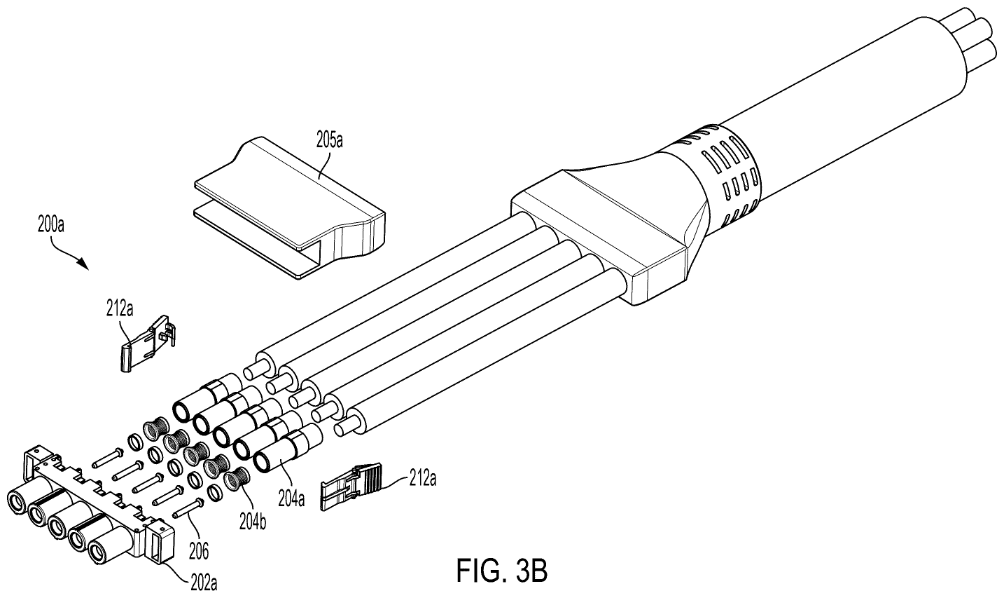

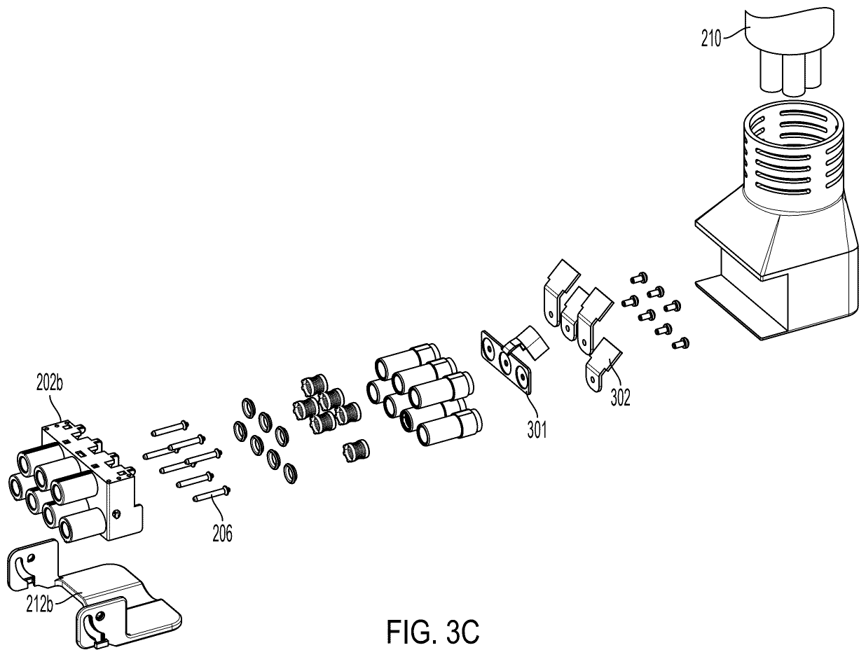

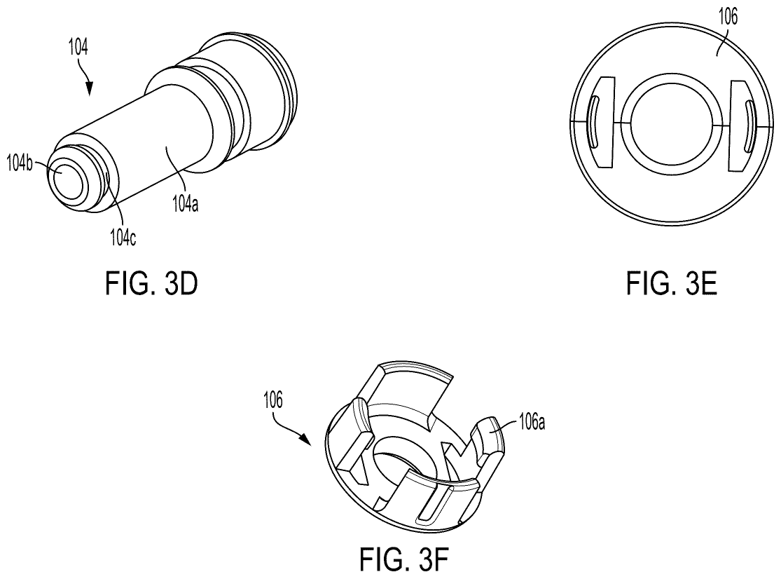

FIG. 2C shows an example of a cable assembly 260 having a receptacle connector 200b configured to mate with plug connector 100b, according to some embodiments. Receptacle connector 200b is illustrated as a right angle connector in which the tubular protrusions 203 extend from a housing 202b at a right angle to the cable bundle 210. Receptacle connector 200b has two rows of tubular protrusions 203 with corresponding contacts 204. In this example, a first row (left side) has four tubular protrusions 203 and the second row (right) has three tubular protrusions 203. In addition to being a right-angle connector that provides a connection from a different angle than receptacle connector 200a, receptacle connector 200b may provide a different form factor from receptacle connector 200a, as receptacle connector 200b may be less wide than receptacle connector 200a and taller than receptacle connector 200a. Other aspects of receptacle connector 200b may be the same as or similar to those of receptacle connector 200a with the same reference numbers. Another difference with receptacle connector 200b compared to receptacle connector 200a is that the one or more securing structures 212b are illustrated to be a rotating latch that is configured to rotate to receive securing structure 212a within a slot of the rotating latch, thereby securing receptacle connector 200b to plug connector 100b. A rotating latch may provide a robust mechanical connection suitable for a right-angle connector. For example, the rotating latch may be rotated toward the distal direction toward the mating direction to be in the “open” position, causing the slots of the rotating latch to face toward the distal direction. The securing structure 112b may be slid into the slot of the rotating latch and the rotating latch may be rotated back into the “closed” position (shown in FIG. 3C) to secure the receptacle connector 200b to the plug connector 100b. Junction block 205b, which may have a cable overmold, provides a region for the conductors of tubular protrusions 203 to be electrically connected to the conductors of cable bundle 210.

Examples have been shown of cable assemblies and board-mounted connectors that either are plug connectors or receptacle connectors. It is appreciated the choice of a plug connector or a receptacle connector may be swapped. For example, in other embodiments (not shown), a corresponding plug version of the cable assembly 250 of FIG. 2A may be formed by replacing receptacle connector 200a with a plug connector similar to plug connector 100a. In other embodiments (not shown), plug connector 100a may be replaced by a plug connector similar to receptacle connector 200a, such that a receptacle connector may be mountable to a substrate 114. In other embodiments, receptacle connector 200b may be replaced by plug connector similar to plug connector 100b.

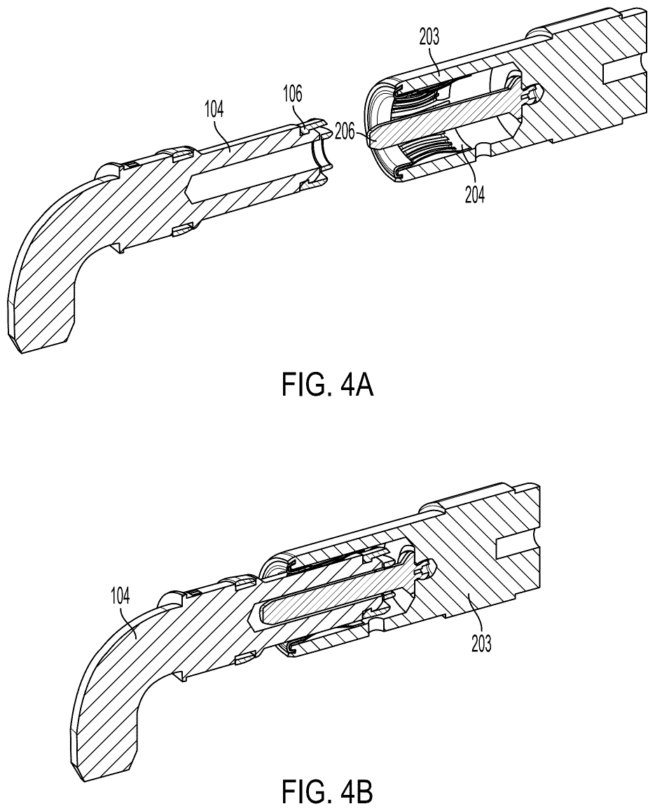

Exploded views of the cable assemblies and connectors will now be discussed. FIG. 3A shows an exploded view of plug connector 100a. As shown, the housing 102a includes recesses 103 for accommodating the plug contacts 104. As shown, one or more of the plug contacts 104 may have tails extending downward at the rear of the plug contact for connection to a PCB. Alternatively, one or more of the plug contacts may connect to a cable, such as cable 110. The insulating caps 106 may be snap-fit onto the ends of the plug contacts 104 or attached to the plug contacts 104 in any other suitable way, such as via epoxy or other adhesive. The ends of the plug contacts 104 may be shaped to receive the insulating caps 106. In the illustrated example, the distal ends of the plug contacts 104 have a channel at the distal end. In this example, the channels extend around the circumference of the plug contacts 104. The insulating caps 106 are concave, with cavities sized to receive the distal ends of the contacts 104. The walls of the insulating caps 106 bounding the cavities are segmented, such that each segment may flex. As can be seen in FIG. 4A, the wall segments may be hooked and may engage the channel of the plug contact 104 when cap 106 is seated on the plug contact 104.

The retention clips 107 serve to retain the plug contacts 104 in the connector housing. Although an exploded view of plug connector 100b is not shown, it should be appreciated that plug connector 100b may have a similar components.

FIG. 3B shows an exploded view of the receptacle connector 200a. In FIG. 3B the generally cylindrical shape of the receptacle contacts 204 can be seen more clearly. The receptacle contacts 204 may have two parts as shown-a rigid cylindrical portion 204a and a compressible portion 204b for pressing against the plug contact 104. Also shown are the insulating pins 206, as well as a number of other components shown in FIG. 2A.

FIG. 3C shows an exploded view of the receptacle connector 200b. In addition to showing a number of components from FIG. 2C, FIG. 3C also shows a commoned ground tab 301 and cable weld tabs 302 that make connections between the receptacle contacts 204 and the cable bundle 210 within the junction block 205b. However, this is an example of connections that may be made, and it should be appreciated the cable bundle 210 may be connected to the receptacle contacts 204 in a different manner.

FIG. 3D shows a perspective view of a plug contact 104, according to some embodiments. Plug contact 104 includes a contact portion 104a for making contact with a complementary receptacle connector, a head portion 104b that can be attached to an insulating cap 106, and a channel portion 104c between the head portion 104b and the contact portion 104a. An insulating cap 106 may be snapped onto the head portion 104b.

FIG. 3E shows a front view of an insulating cap 106. As shown, insulating cap 106 may have an opening in the center for accommodating an insulating plug. The insulating cap 106 may also have other openings, as shown.

FIG. 3F shows a rear perspective view of the insulating cap 106, showing the insulating cap has a plurality of tabs 106a configured to fit over the head portion 104b to retain the insulating cap 106 on the plug contact 104.

FIGS. 4A and 4B show a plug contact 104 prior to and following mating with a receptacle contact 204, respectively. The plug contact 104 includes a central hole to accommodate the insulating pin 206. FIG. 4A also shows more detail of an example of a receptacle contact 204. As shown, receptacle contact 204 may have a plurality of conductive strips (e.g., of metal) that bow or otherwise protrude in an inward direction. When the plug contact 104 is inserted into tubular protrusion 203, the plug contact 104 presses against the plug contact 104 in an outward direction, causing the receptacle contact to compress from its initial bowed or otherwise inward protruding position. The receptacle contact 204 exerts an inward force on the plug contact 104 by the spring-like action of the receptacle contact 204, which provides a strong electrical and mechanical connection. In other embodiments, the receptacle contact 204 may take the form of tabs or other protrusions that press against the plug contact 104.

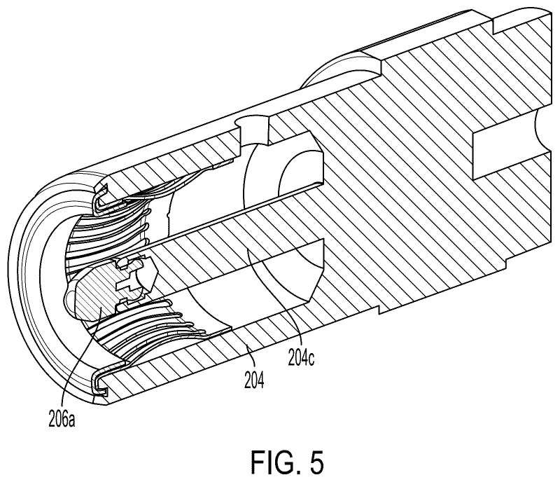

FIG. 5 shows another example of a receptacle connector. In this example, the contact 204 includes an inner protrusion 204c that extends in a central portion of a tubular protrusion along a plugging and unplugging direction. The inner protrusion 204c is a conductive portion of the contact 204. The inner protrusion 204c may be a machined portion of the contact 204. An insulating pin 206a of smaller length than insulating pin 206 is attached to the distal end of the inner protrusion 204c. As shown in FIG. 5, the insulating pin 206a may attach within the center of the inner protrusion 204c, as shown with a groove for engaging 204c and a retention portion that seats within a groove of inner protrusion 204c.

Having thus described several aspects of at least one embodiment of this invention, it is to be appreciated that various alterations, modifications, and improvements will readily occur to those skilled in the art. Such alterations, modifications, and improvements are intended to be within the spirit and scope of the invention. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between 10 and 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. When only exact values are intended, the term “exactly” is used, e.g., “between exactly 2 and exactly 200.” Similarly, when a value, such as a dimension is recited without the term “exactly” the value may vary by 5%, 10% or up to 20% in various embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A receptacle connector, comprising:
a housing having tubular protrusions, the tubular protrusions having receptacle contacts at inner sides of the tubular protrusions, the tubular protrusions extending along a plugging and unplugging direction of the receptacle connector; and
insulating pins extending within the tubular protrusions along the plugging and unplugging direction of the receptacle connector.

2. The receptacle connector of claim 1, wherein the insulating pins protrude from an interior of the tubular protrusions to an exterior of the tubular protrusions.

3. The receptacle connector of claim 1, wherein the insulating pins are attached to the housing within the tubular protrusions.

4. The receptacle connector of claim 3, wherein the insulating pins are attached to the housing at proximal ends of the tubular protrusions.

5. The receptacle connector of claim 3, wherein the receptacle contacts includes inner protrusions extending within the tubular protrusions along the plugging and unplugging direction of the receptacle connector, and the insulating pins are attached to distal ends of the inner protrusions.

6. The receptacle connector of claim 5, wherein the inner protrusions are conductive.

7. The receptacle connector of claim 1, wherein the insulating pins are positioned at central portions of the tubular protrusions.

8. The receptacle connector of claim 1, wherein the insulating pins are configured to prevent a person from contacting the receptacle contacts.

9. The receptacle connector of claim 1, further comprising at least one securing structure configured to attach the receptacle connector to a plug connector.

10. The receptacle connector of claim 9, wherein the at least one securing structure comprises a rotating latch.

11. The receptacle connector of claim 1, wherein the tubular protrusions are arranged in at least one row.

12. The receptacle connector of claim 11, wherein the tubular protrusions are arranged in a single row and a quantity of tubular protrusions arranged in the single row is five.

13. The receptacle connector of claim 11, wherein the tubular protrusions are arranged in a first row and a second row, a quantity of tubular protrusions arranged in the first row is four, and a quantity of the tubular protrusions arranged in the second row is three.

14. A cable assembly comprising the receptacle connector of claim 1, the cable assembly further comprising:
a cable overmold at a proximal end of the housing;
cables electrically connected to the receptacle contacts, the cables extending from a proximal end of the cable overmold, wherein the cables are arranged in a single row; and
a junction block attached to proximal ends of the cables, the junction block being configured to connect the cables to a cable bundle.

15. The receptacle connector of claim 1, wherein the receptacle connector is a right-angle connector.

16. A plug connector, comprising:
a housing including recesses, the recesses having plug contacts extending along a plugging and unplugging direction of the plug connector, wherein the plug contacts have holes extending along the plugging and unplugging direction of the plug connector, wherein the holes are configured to accommodate insulating pins of a receptacle connector.

17. The plug connector of claim 16, further comprising insulating caps attached to distal ends of the plug contacts.

18. The plug connector of claim 17, wherein the insulating caps have holes to accommodate the insulating pins.

19. The plug connector of claim 16, wherein the plug contacts have an external cross-section that is circular.

20. The plug connector of claim 19, wherein an outer diameter of the plug contacts is approximately eight millimeters.

21.-32. (canceled)

33. A cable assembly, comprising:
a connector, including:
a housing having a plurality of openings extending along a plugging and unplugging direction of the connector;
a plurality of contacts within respective openings of the plurality of openings; and
insulating structures within the respective openings so as to make the connector touch proof;
a cable bundle comprising a plurality of cables electrically coupled to the plurality of contacts, respectively; and
a junction block comprising a plurality of conductive members attached to the plurality of cables.

34. The cable assembly of claim 33, further comprising cables electrically connected to the plurality of contacts, the cables extending from a proximal end of the junction block, wherein the cables are arranged in a single row.

35. (canceled)

36. The cable assembly of claim 33, wherein:
the junction block is configured such that at least some of the plurality of cables are each coupled to multiple contacts of the plurality of contacts.
